(19) United States
(12) Patent Application Publication
(10) Pub. No.: US 2005/0271764 A1
(43) Pub. Date: Dec. 8, 2005

(54) Flaring tool

(76) Inventors: Jeffrey J. McKenzie, Watertown, MN (US); James C. Linder, Shorewood, MN (US); Michael A. Stein, Eden Prairie, MN (US); James M. Anderson, St. Michael, MN (US); Donald D. Ware, St. Paul, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/108,618

(22) Filed: Apr. 17, 2005

Related U.S. Application Data
(60) Provisional application No. 60/563,378, filed on Apr. 18, 2004.

(51) Int. Cl. B28B 11/00

(52) U.S. Cl. 425/392

(57) ABSTRACT

A tool and method for flaring plastic tubing provides efficiency and rapidity. The tool has interchangeable clamping portions for different sized tubing, different manually inserted mandrels for the different sized tubing, and automated clamping, heating, and flaring operations.

This application claims priority to U.S. provisional Application 60/563,378, filed Apr. 18, 2004, entitled “FLARING TOOL”, which is incorporated herein by reference.

### FIELD OF THE INVENTION

This invention relates to methods and equipment for performing operations on tubing, more particularly, the invention relates to methods and tools for flaring plastic tubing.

### BACKGROUND OF THE INVENTION

In certain processes, for example in the semiconductor processing industry and the pharmaceutical industry, plastic tubing has replaced metal piping and tubing. In industries where the fluids being handled are highly caustic or corrosive, fluoropolymer tubing is appropriate. Generally, PFA is the type of tubing used is such applications. Connections of PFA tubing may be by welding or through nonwelded connections. A highly robust and reliable connection of PFA tubing is formed by creating a flared tubing end. Such flared end having a second tubular section of a constant radius extending axially for a limited distance and are joined to a nipple by a nut.

Conventional means of forming such flared ends involved heating the tubular end and then inserting a form sized for the flare. The flare is allowed to air cool and then the form is removed. The conventional methods of heating the end, although quite effective, are time consuming. The form is inserted generally with suitable tools to assure proper alignment and depth of insertion. Converting such tools to different sized tubing has been problematic. Moreover, automation to assure proper and optimal heating and cooling times has been lacking.

Also, flared ends of tubing have been “cold” formed without heat by forcibly inserting forms into the ends of such tubing. Flared ends formed by this methodology tend to creep back towards their original shape much more readily than those formed with heat.

### SUMMARY OF THE INVENTION

A flaring tool with an electric heater and automated clamping and control features provides efficiency, repeatability, high level of quality, and rapidity in creating flared ends of different sizes of tubing. The tool comprises a set of differently sized mandrels for the different sizes of tubing, a flaring portion and a control portion. The flaring portion has a set of clamping portions each sized to a respective tubing size. Each mandrel preferably has a first end portion that is sized to the respective inside tubing diameter, a flaring portion sized to the inside of the flaring to be performed, and a shank portion for handling.

The tubing end to be flared is first fitted with a mandrel partially inserted, that is, the first end portion is inserted until the flaring portion abuts against the tip of the tubing. The tubing with the mandrel partially inserted is then inserted into the flaring portion of the tool and the clamping portion is actuated supported the tube. The heating and forming sequence is actuated. The flaring portion first heats the end of the tubing to an appropriate level, then drives the mandrel further into the tubing effecting the flare. The heat is maintained a suitable time to allow the flare to “take” and then the heat is removed. The end with mandrel still in place is removed and the end is allowed to cool a suitable amount, the clamp is opened and the tubing end with the mandrel is removed. The tubing end may then be further rapidly cooled such as by immersion in water and the mandrel is removed.

The flaring portion may be portable and connected to the control portion by cabling permitting flaring of tubing that is already connected into installations. The flaring portion preferably has replaceable clamping sections, which are interchangeable on the flaring portion and include a identification means, such as keying, for identifying the specific tubing size to the control portion for setting the appropriate predetermined flaring parameters. A toggle clamp in the clamping section effectuated by a linear actuator is preferably used to grasp the tubing. A heater portion receives the tubing end with the mandrel inserted therein and is spaced from the tubing and mandrel during the heating and preferably has the heating element wires unexposed to the tubing end within the heating section. In preferred embodiments, a blower operates to equalize heat distribution around the heating head and/or tubing end being flared precluding excessive heating of the tubing and mandrel during the flaring operation. The heating portion can be maintained at a preheat temperature when turned on and between flarings to minimize the individual sequence time.

A feature and advantage of certain aspects and embodiments of the invention is that more flarings can be accomplished in less time than with other conventional flaring tools. The use of mandrels separate from the tool allows the tube and mandrel to be removed from the tool sooner than they otherwise could be removed.

A further feature and advantage of certain aspects and embodiments of the invention the same tool can be used for different sizes of tubing.

A further feature and advantage of certain aspects and embodiments of the invention is that the clamping portion can be changed out to accommodate different sizes of tubing and the heating parameters are automatically changed with placement of the new clamping portion.

### DESCRIPTION OF THE FIGURES

FIG. 1 is a perspective view of components the tool system in accord with the inventions herein.

FIG. 2 is a front elevational view of a mandrel in accord with the inventions herein.

FIG. 3 is a perspective view of a flaring portion in accord with the inventions herein.

FIG. 4 is a front elevational view of a clamping portion in accord with the inventions herein.

FIG. 5 is a side elevational view of the clamping portion of FIG. 4.

FIG. 6 is a perspective view of the clamping portion of FIG. 4.

FIG. 7 is a cross-sectional view of the clamping portion of FIG. 4 taken at line 7-7.

FIG. 8 is a rear perspective view of a flaring portion in accord with the inventions herein.

FIG. 9 is a front perspective view of the flaring portion of FIG. 8.

FIG. 10 is an exploded view of the flaring portion of FIG. 8.

FIG. 11 is a front perspective view of a heater assembly in accord with the inventions herein.

FIG. 12 is an exploded view of the heater assembly of FIG. 11.

FIG. 13a is an operational flowchart of the use of a flaring tool in accord with the inventions herein.

FIG. 13b is an operational flowchart of the use of a flaring tool in accord with the inventions herein.

FIG. 13c is an operational flowchart of the use of a flaring tool in accord with the inventions herein.

FIG. 14 is a pictorial illustrating a summary of the steps involved in the flaring operation in accord with the inventions herein.

FIG. 15 is a chart illustrating exemplary operation steps for use of a flaring tool in accord with the inventions herein.

### DETAILED DESCRIPTIONS OF PREFERRED EMBODIMENTS

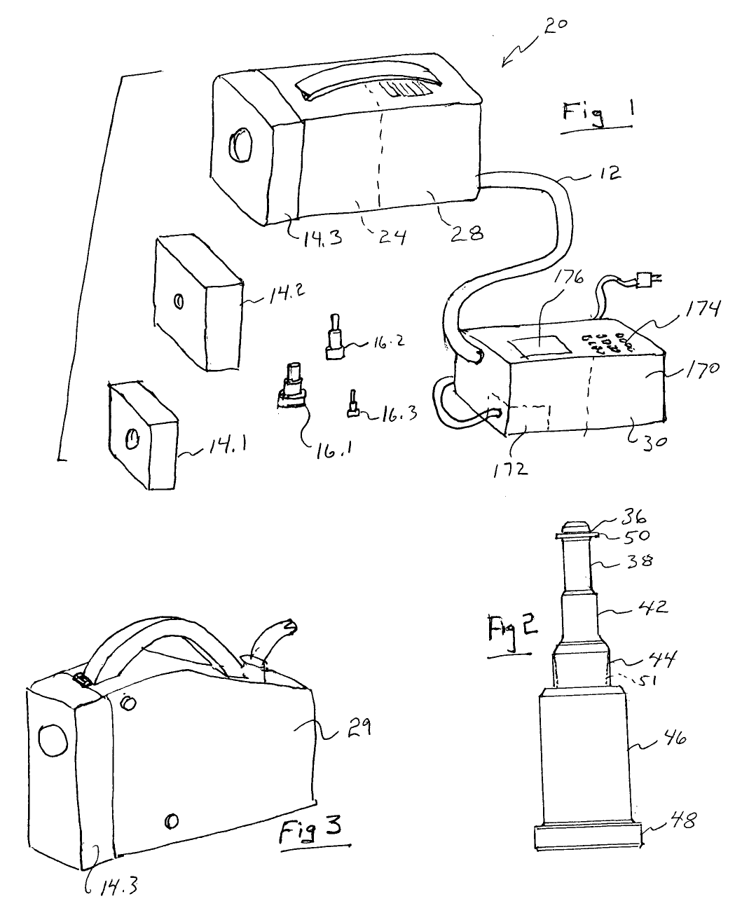

Referring to FIG. 1, a flaring system for creating flares on different sizes of plastic tubing, particularly fluoropolymer tubing, such as PFA (perfluoroalkoxy) comprises generally a flaring tool 20 with different interchangeable clamping portions 14.1, 14.2, 14.3 and a plurality of mandrels 16.1, 16.2, 16.3 corresponding to the different sizes of tubing. The flaring tool comprises the clamping portion, a heating portion 24, a forming portion 28 for driving the mandrel into the softened tubing, and a control portion 30. The combined heating portion 24 and forming portion 28 are preferably structurally interconnected to form a base flaring tool 29. The control portion may be separated by cabling 32 as illustrated, or may be contained in the unit having the heating portion, clamping portion, and forming portion for driving the mandrel, or maybe split between two discreet units.

FIG. 2 illustrates in detail a mandrel suitable for use with the flaring tool disclosed herein. The mandrel has a tip 36, a non contact portion 38, a tubing engaging portion 42, a flare forming portion 44, a handling shank 46, and a flange 48. The tubing engagement portion is sized to approximately the inside diameter of the tubing to be flared. The tip has a retention portion 50 that is preferably sized slightly larger than the inside diameter of the tubing whereby the mandrel is retained in the tubing end. The mandrel may be formed of various fluoropolymers such as PTFE or may be formed of other temperature resistant polymers such as PEEK. It has been found that a black mandrel improves heating times. Metals may also be appropriate in some applications. The shape of the flare forming portion may have a slight undercut 51 indicated by the dotted lines to facilitate retention of the mandrel in the tubing end during removal from the tool and during cooling.

FIG. 3 illustrates another configuration of a unit comprising a clamping portion, a heating portion, and a forming portion with a housing 54 enclosing internal componentry. A user switch 55 is mounted on the housing and is connected to the control portion.

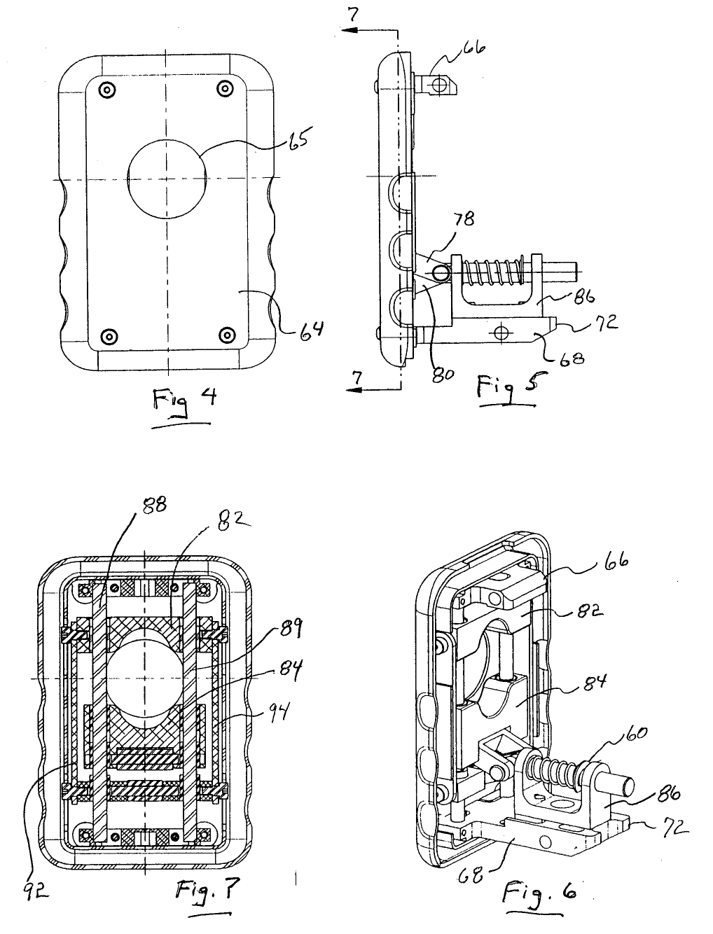

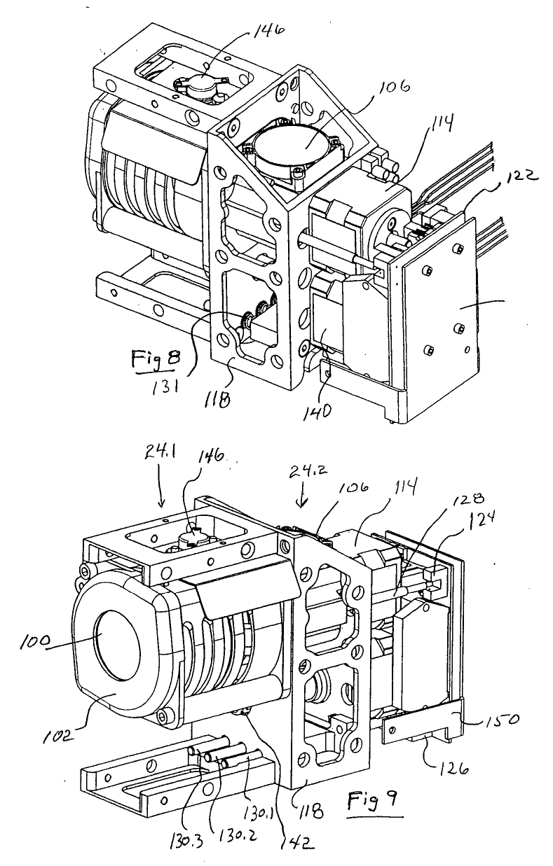

Referring to FIGS. 4, 5, 6, and 7, various view of a clamping portion are illustrated. Illustrated. In this preferred embodiment, the clamping portion comprises primarily a toggle clamp mechanism 60, a front housing 64 with an aperture 65, upper and lower base unit engagement brackets 66, 68, and a keyed portion 72. The toggle clamping mechanism has a plunger 76, a pair of toggle links 78, 80, a pair of clamping jaws, 82, 84 a plunger slide bracket 86, clamping portion guide rails 88, 89, spring 90, and upper clamping portion linkages 92, 94. Driving the plunger inwardly spreads the toggle links, which raise the lower clamping portion 84 and lowers the upper clamping portion 82 through the links 92, 94. The componentry is preferably conventionally formed from steel, aluminum or other suitable metal.

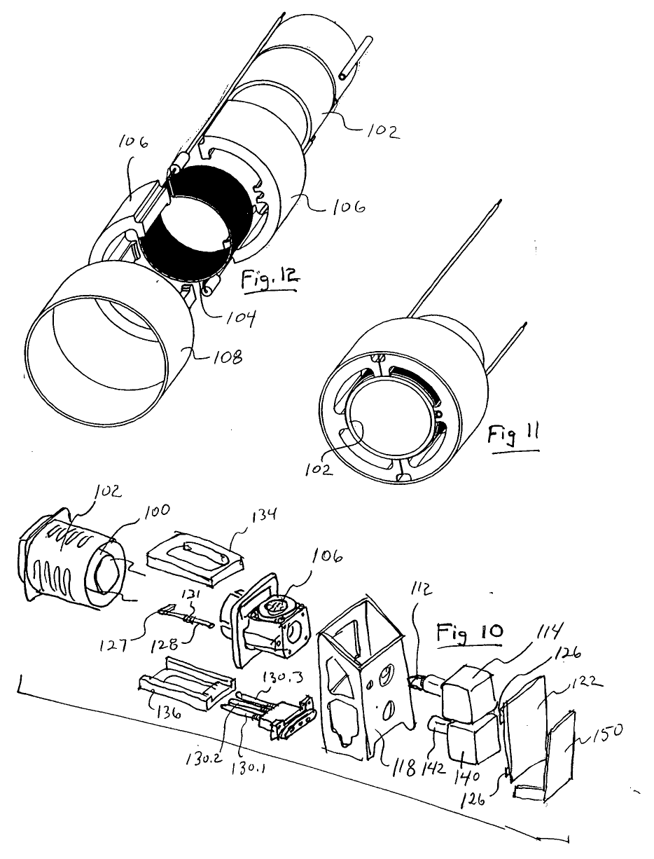

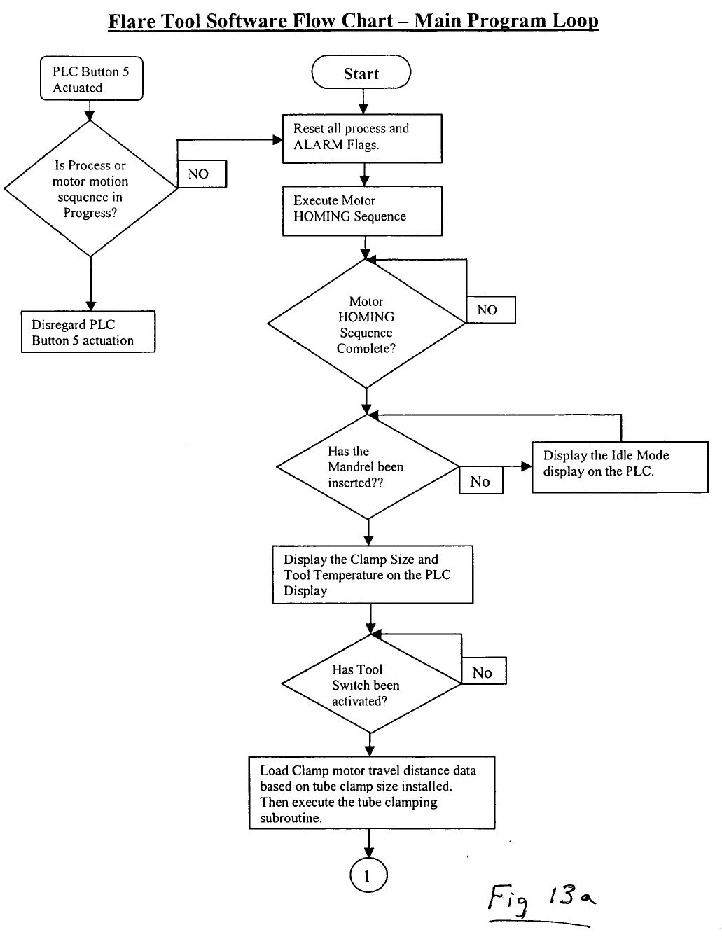

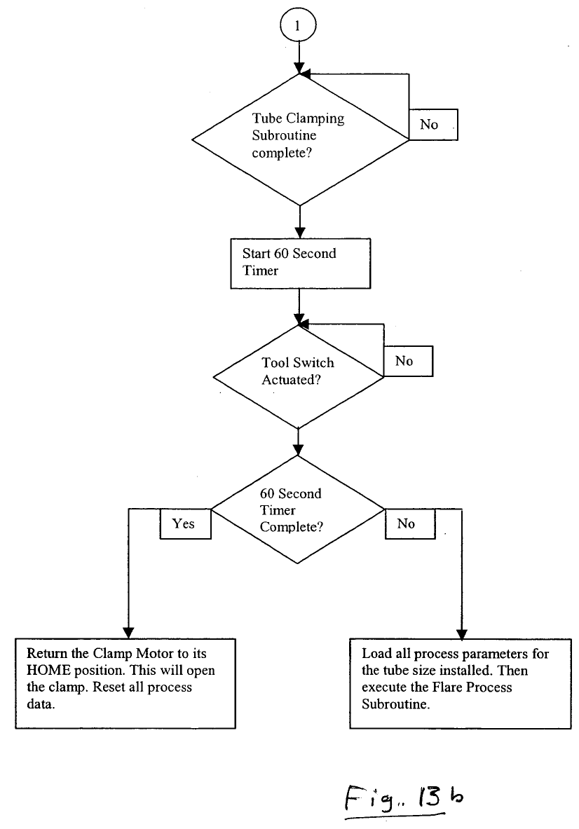

Referring to FIGS. 8, 9, and 10 the heating portion 24.1 and forming portions 24.2 and components thereof are illustrated. The heating and forming portions are not required to be in isolation and discreet with respect to each other and the portions may share components and are intimately connected in preferred embodiments. The heating portion comprises primarily a heater 100 that is contained within a shroud 102 and has a fan 106 in proximity thereto to cool the attached components and importantly to provide uniform heating by the heater to the tubular end.

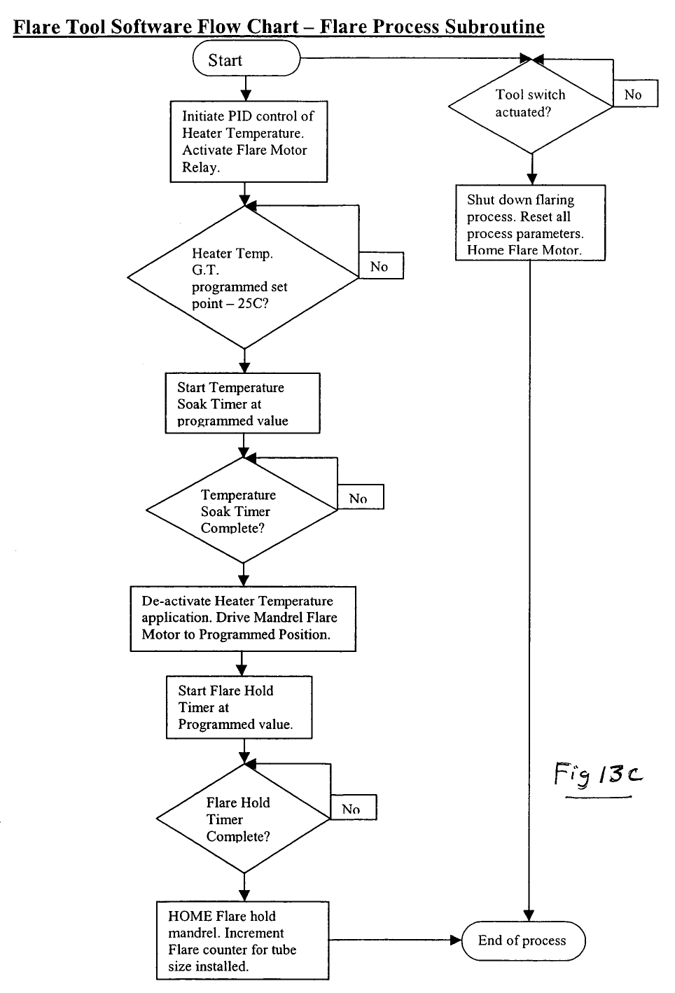

Referring to FIGS. 11 and 12, the heater 100 is constructed preferably of a quartz tubing 102 that surrounds the tubing end and mandrel, a coil of heater wire 104, ceramic forms 106, and insulating fabric 108. Notably, the heater wire is not exposed to the receiving area of the flaring tool being separated by the quartz tubing.

Referring again to FIGS. 8, 9, and 10, the forming portion comprises a mandrel drive portion 112, that is connected to a linear drive motor 114 that is mounted to a housing 118. The base flaring unit having the combined heating portion and forming portion includes a circuit board 122 that has switches 124, 126, such as optical switches, for sensing presence of a tubing and mandrel to be welded and to provide keying for identification of the particular clamping portion that is attached to the base flaring unit. Tab 127 is engaged and depressed by an inserted mandrel and rod 128 extends back to the opto 124 to activate same. Rods 130.1, 130.2, 130.3 provide the actuation of three optos 126 triggered by the keying on the clamping portions. All of the rods are preferably biased to the normally open position by springs 131. Tracks 134, 136 for receiving the upper and lower base unit engagement brackets 66, 68 are suitably attached to the housing 118 and provide the engagement means with each of the clamping portions 14.1, 14.2, 14.3. An additional linear drive motor 140 with pad 142 is utilized to depress the plungers of the particular clamping portion attached to the base unit. A thermostat 146 measures a suitable heater temperature and relays same to the control portion. Bracket 150 may secure the circuit board and other componentry to the assembly.

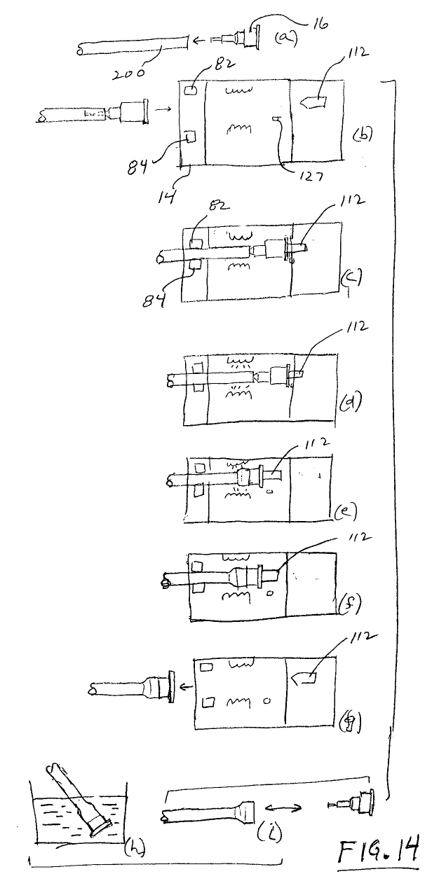

The control portion 30 comprises a processing portion 170, a power supply portion 172, data entry portion 174, display portion 176, and the switching and motor operating componentry. Suitable microprocessor control and operation are incorporated into the control portion. Suitable programming for the operation of the flaring tool is illustrated by the flow charts of FIGS. 13a, 13b, and 13c. Exemplary operating instructions are illustrated by the chart of FIG. 15.

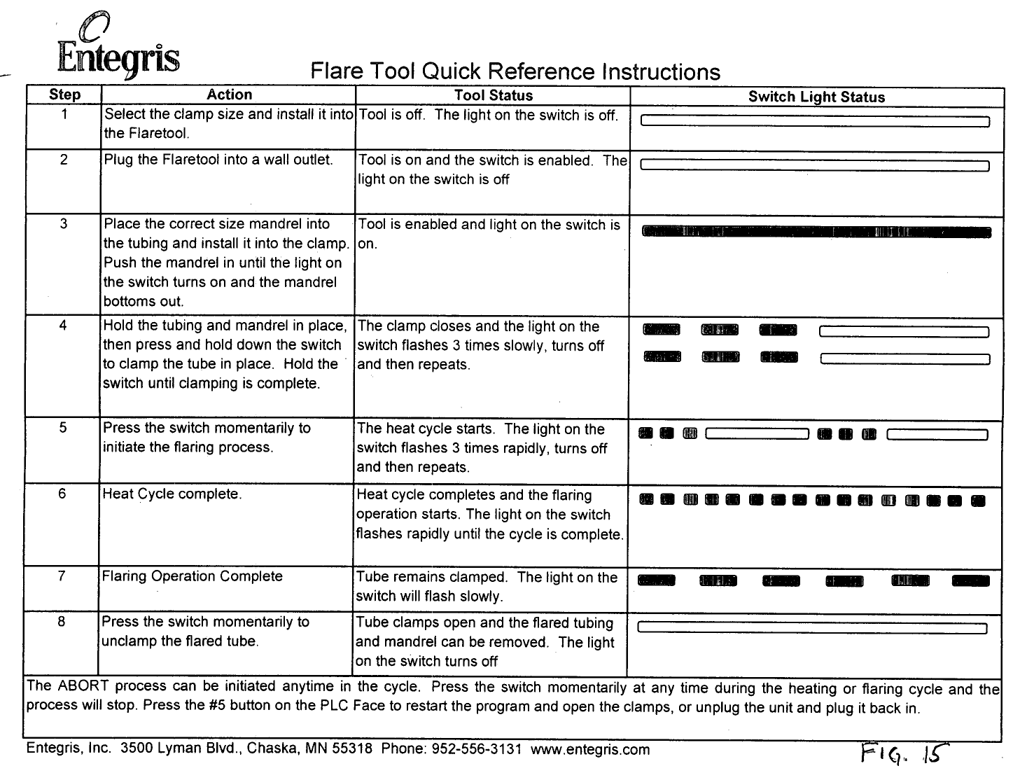

Referring primarily to FIG. 14, the methodology of using the flaring tool and system is pictorially illustrated. The other figures may be referenced as well to see a specific preferred configuration of the particular elements. First, depending upon the size of tubing to be flared, the appropriate mandrel and clamping portion are selected. The appropriate clamping portion is attached to the base unit if not already attached. The control portion identifies the tubing size from the keying 72 on the clamping portion, which actuates a particular combination of opto switch bank 126. The selected mandrel 16 is partially inserted into the tubing end until the flaring portion abuts against the tubing end 200. The tubing end with mandrel is then inserted into the aperture of the clamping portion until they are stopped which effects depression of tab 127 which actuates opto switch 124 notifying the control portion. A indicator light or other means indicates the tubing end and mandrel are “home”. The operator may then effect the flaring by depressing the switch 55. The motor 140 driving the toggle clamping plunger is actuated whereby the clamping jaws 82, 84 close to clamp the tubing end. The mandrel spud 112 is moved into engagement with the mandrel if not already suitably positioned. The heater is preferably already preheated and is then actuated by the control portion to heat up to around 700 degrees Celsius. This is maintained a suitable amount of predetermined time so that the tubing end reaches a temperature of approximately 500 degrees Fahrenheit. At this point, as determined by the control portion, the linear motor 114 that drives the mandrel spud is actuated to force the mandrel further into the tubing end; specifically the flaring portion 44 is driven in thus expanding the end of the tubing. The heat is maintained a suitable predetermined amount of time. The heat is then tapered off, the mandrel spud retracted, the clamping jaws open, and the tubing and mandrel are removed from the flaring tool. The tubing end may then be immersed in fluid, such as water, to accelerate cooling, and the mandrel is pulled out of the flared tubing end.

1. A method of flaring a tubing end portion of a specific size with an automated flaring tool with a control portion, the method comprising the steps of:
a user selecting a clamping portion correlating to the specific size of the tubing end portion to be flared from a set of clamping portions of varying sizes
identifying to a control portion of a flaring tool the specific size of the tubing end portion by registration of a keyed portion of the clamping portion with the flaring tool;
selecting a flaring routine by the control portion based upon the identification of the specific size of the tubing end portion; and

2. The method of claim 1 further comprising the step of insertion of a tubing end portion of the selected size into an opening in the automated flaring tool and recognizing the receipt of the tubing end portion by the control processor.

3. The method of claim 2 further comprising the step of initiation of the selected flaring routine by the control portion based upon recognition of the receipt of the tubing end portion

4. The method of claim 3 further comprising the step of clamping the tubing end portion by the clamping portion controlled by the control processor.

5. The method of claim 4 further comprising the step of providing heat from the heating portion to the tubing end portion, said providing heat controlled by the control processor.

6. The method of claim 5 further comprising the step of driving a mandrel into the tubing end portion after the tubing end portion has been heated.

7. The method of claim 6 further comprising the step of manually partially inserting a mandrel into the tubing end portion before the tubing end portion is inserted into the flaring tool.

8. A method of flaring a tubing end portion of a specific size with a flaring tool, the flaring tool comprising a clamping portion, a heating portion and a formation portion together as a single portable unit, the method comprising the steps of:
inserting a tubing end portion into the flaring tool;
clamping the tubing end portion into a fixed position with respect to the flaring tool;
providing heat from the heating portion to the tubing end portion;
driving a mandrel into the tubing end portion after the tubing end portion has been heated;

9. The method of claim 8 further comprising the step of manually partially inserting a mandrel into the tubing end portion before the tubing end portion is inserted into the flaring tool.

10. A tool for radially expanding a polymer tubing end portion for making a flared fitting connection, the tool comprising:
a clamping portion, a heating portion, and a forming portion secured in a single portable unit;
the clamping portion having a clamp mechanism for grasping the tubing end portion;
the heating portion for providing heat to the tubing end portion; and
the forming portion including an axial drive member for powered insertion of a forming mandrel into the tubing end portion.

11. The tool of claim 10, wherein the clamping portion, the heating portion, and the forming portion are each electrically powered.

12. The tool of claim 11 further comprising a control portion that automatically controls the heating portion and the forming portion.

13. The tool of claim 12 further comprising a housing having an aperture for receiving the tubing end portion and further comprising a sensor for determining when a tubing end portion has been inserted into the aperture.

14. The tool of claim 10 further comprising a plurality of mandrels for insertion in tubing end portions, the plurality of mandrels being of different sizes for different diameters of tubing end portions.

15. The tool of claim 10 wherein the tubing mandrels each have a nose section sized for preinsertion and retention into the tubing end portion before the tubing end portion is inserted into the tool.

16. The tool of claim 14 further comprising a plurality of clamping portions, the plurality of clamping portions each being of a different size for different diameters of tubing end portions and each being removably attachable to a connector portion on the tool.

17. The tool of claim 16 further comprising a control portion that automatically controls the heating portion and the forming portion and wherein each clamping portion is keyed for a particular size tubing and wherein the tool comprises a key sensor to signal the control portion data relating to the specific clamping portion.

18. The tool of claim 10 wherein the heating portion further comprises a quartz tubing portion into which the tubing end portion is inserted.

19. A method of coupling tubing end portions, the method comprising the steps of:
selecting a tubing with a tubing end portion;
utilizing a tool according to claim 10 for forming a flare with a flared section with an enlarged tubular section with a constant radius extending axially as part of the flare;
attaching the tubing end portion to a nipple fitting with a nut thereby making a connection.
